(19) United States
(12) Patent Application Publication
(10) Pub. No.: US 2009/0137290 A1
(43) Pub. Date: May 28, 2009

(54) Wireless Telephone Housing Providing Enhanced Heat Dissipation

(76) Inventors: Scott P. Overmann, Allen, TX (US); Amit A. Kulkarni, Highland Village, TX (US); Daniel J. Morgan, Denton, TX (US)

Correspondence Address: TEXAS INSTRUMENTS INCORPORATED, P O BOX 655474, M/S 3999, DALLAS, TX, 75265, US

(21) Appl. No.: 11/945,090

(22) Filed: Nov. 26, 2007

(51) Int. Cl. H04M 1/00

(52) U.S. Cl. 455/575.1

(57) ABSTRACT

According to one embodiment of the disclosure, a wireless telephone generally includes a housing and a heat spreading member. The housing encases a plurality of electrical components of a wireless telephone. The heat spreading member is in thermal communication with at least two distally located portion for reducing a thermal gradient over the surface of the housing.

### TECHNICAL FIELD OF THE DISCLOSURE

This disclosure generally relates to wireless telephones, and more particularly, to a wireless telephone housing that provides enhanced heat dissipation.

### BACKGROUND OF THE DISCLOSURE

Wireless telephones, also referred to as mobile telephones or cellular telephones, have enabled portable communication of individuals with one another. Technological advances have enabled the creation of wireless telephones that are relatively small in size compared to earlier wireless telephone designs. Other technological advances that have been implemented on wireless telephones include various communication services, such as text messaging, e-mail, Internet access, and multi-media services. Use of these communication services in conjunction with the relatively portable nature of known wireless telephone designs have provided enhanced connectivity for individuals.

### SUMMARY OF THE DISCLOSURE

According to one embodiment of the disclosure, a wireless telephone generally includes a housing and a heat spreading member. The housing encases a plurality of electrical components of the wireless telephone. The heat spreading member is in thermal communication with at least two distally located portions of the housing for reducing a thermal gradient over the surface of the housing.

Some embodiments of the invention provide numerous technical advantages. Some embodiments may benefit from some, none, or all of these advantages. For example, according to one embodiment, heat dissipation may be provided over a relatively larger portion of the wireless telephone housing that may in turn, reduce the effective thermal resistance of the wireless telephone housing. For wireless telephone housings that are typically made of plastic, this distributed heat dissipation may alleviate the formation of hot spots on specific regions of the wireless phone housing during operation of the wireless telephone.

Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a perspective view of one embodiment of a wireless telephone that is operable to display a two-dimensional image;

FIG. 2 is a cut-away, side elevational view of the wireless telephone of FIG. 1 incorporating one embodiment of a wireless telephone housing according to the teachings of the present disclosure;

FIG. 3 is a cut-away, side elevational view of another embodiment of a wireless telephone housing according to the teachings of the present disclosure; and

FIG. 4 is a graph showing the luminous intensity as a function of operating temperature of one embodiment of a light generating device that may be used with the embodiments of FIG. 2 or 3.

### DETAILED DESCRIPTION OF EXAMPLE EMBODIMENTS

As described previously, a number of communication services have been implemented for use on wireless telephones. One particular communication service that has been implemented on wireless telephones is a multi-media communication service that may include streaming of images to and from the wireless telephone. Viewing of these images has been provided by a liquid crystal display (LCD) screen configured on the housing of the wireless telephone. The liquid crystal display screen, however, may have a relatively limited view area due in large part, to the relatively small physical size of the wireless telephone. Spatial light modulators, such as digital micro-mirror devices, scanning mirrors, liquid crystal on silicon (LCOS) devices, and transmissive liquid crystal displays have been developed that may provide a larger viewing area by enabling projection onto a two-dimensional surface external to the wireless telephone; however, light generating devices used to illuminate these spatial light modulators may generate an undue amount of heat during operation and may therefore, hinder or preclude implementation of these spatial light modulators in the relatively small wireless telephone.

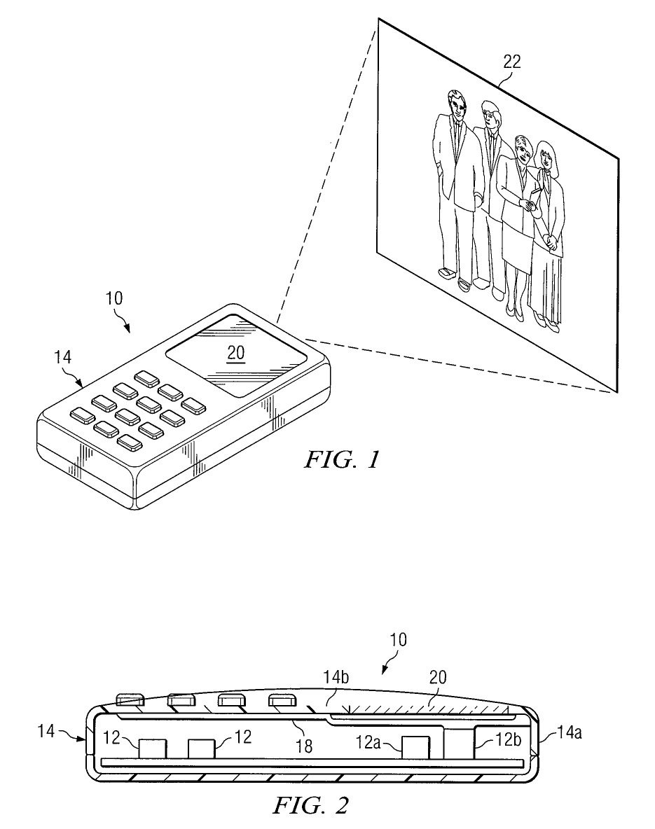

FIG. 1 shows a wireless telephone 10 according to the teachings of the present disclosure. Wireless telephone 10 may be any type of device suitable for displaying information stored in a memory or streamed to the wireless telephone 10 using a wireless connection. Wireless telephone 10 has a wireless telephone housing 14 and a display 20 for displaying various forms of information that may include images for providing multi-media communication services to a user and/or images generated from information stored in a memory configured in the wireless telephone 10. In one embodiment, wireless telephone 10 may be operable to create a two-dimensional image 22 external to the wireless telephone 10 using a light generating device and spatial light modulator as described in detail below. According to the teachings of the present disclosure, wireless telephone 10 may incorporate a heat spreading member for transferring heat over various portions of the wireless telephone housing 14 for enhanced dissipation of heat generated by light generating devices or other electrical components that may generate heat.

FIG. 2 is a side cross-sectional view of the wireless telephone 10 of FIG. 1. As shown, wireless telephone 10 may have a number of electrical components 12 that are encased in wireless telephone housing 14. Wireless telephone housing 14 is configured to encase a number of electrical components 12. According to the teachings of the disclosure, wireless telephone 10 has a heat spreading member, which in this particular embodiment is a heat pipe 18, in thermal communication with a housing portion 14a and a housing portion 14b that are distally located relative to one another. The heat pipe 18 is thermally conductive to promote movement of heat from one housing portion 14a to another housing portion 14b. Certain embodiments incorporating heat spreading members such as heat pipes 18 may enable heat generated by electrical components 12 to be dissipated to the environment in a relatively efficient manner.

The wireless telephone housing 14 may be configured to dissipate heat generated by any electrical component 12 of the wireless telephone 10. In one embodiment, a particular electrical component 12 of the wireless telephone 10 may be a light generating device 12b that is configured to generate light used by a spatial light modulator 12a to produce the two-dimensional image 22. In another embodiment, spatial light modulator 12a is a digital micro-mirror device (DMD) in which light from light generating device 12b is reflected in order to form the two-dimensional image 22. In one embodiment, the light generating device 12b may be thermally coupled to the housing 14 by being in contact with a portion of the heat pipe 18.

Light generating device 12b may be any device suitable for generating radiant energy in the visual light spectrum. In one embodiment, light generating device 12b may be one or more light emitting diodes. In another embodiment, light generating device 12b may be one or more laser devices. Due to a limited efficiency of operation, these light generating devices 12b may produce heat during operation. For example, a particular laser light source providing sufficient luminous intensity for use with a spatial light modulator 12a may produce approximately 1.0 watt of heat during operation. To dissipate this amount of heat, the light generating device 12b may be thermally coupled to the wireless telephone housing 14. Typical materials from which known wireless telephone housings are made, however, may have relatively poor thermal conductivity and thus cause “hot spots” proximate the portion of the wireless telephone housing 14 that is thermally coupled to the light generating device 12b. Certain embodiments incorporating a heat spreading member, such as heat pipe 18, may provide an advantage in that heat generated by various electrical components 12, such as light generating devices 12b, may be spread over multiple portions of the housing 14 for enhanced dissipation of heat.

In one embodiment, wireless telephone housing 14 may be formed of a generally thermally conductive material, such as magnesium or graphite composition having relatively good thermally conducting properties. In another embodiment, heat pipe 18 may be included to spread heat over various distally separate portions of the housing 14. Heat pipe 18 may be thermally coupled to different portions of the housing 14 using any suitable thermal coupling approach, such as thermally conductive epoxy or thermal grease. In another embodiment, heat pipe 18 may be integrally formed with the wireless telephone housing 14. A heat pipe generally refers to a type of elongated device that may include a liquid/vapor material disposed in an inner cavity for movement of heat using the material's latent heat of vaporization. The heat pipe 18 shown has a generally round cross-sectional shape; however, the heat pipe 18 may have any cross-sectional shape that allows heat to be conveyed along its elongated extent. In one embodiment, the display 20 may be free of contact with the heat pipe 18. That is, the heat pipe 18 may be disposed away from the display 20 of the wireless telephone 10 such that heat transferal from electrical components 12, such as light generating device 12b, to display 20 may be reduced.

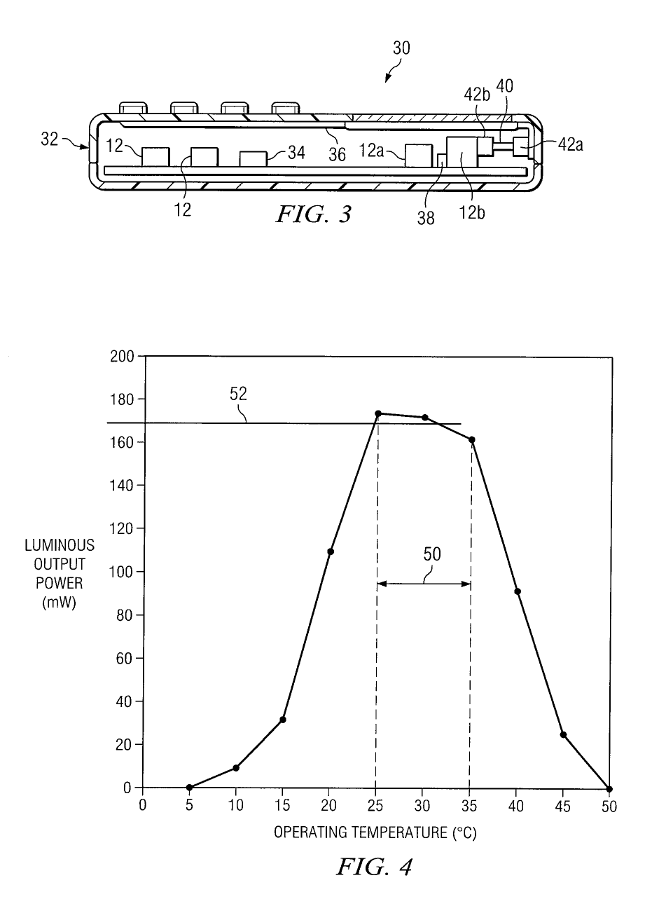

FIG. 3 shows a cross-sectional view of another embodiment of a wireless telephone 30 according to the teachings of the present disclosure. The wireless telephone 30 has a housing 32 that is similar in design and purpose to the housing 14 of the wireless telephone 10 of FIG. 1. The wireless telephone housing 32 of FIG. 3 differs, however, in that heat spreading member is an inner lining 36 that is generally flat in shape, having a contour that generally conforms to the inner contour of housing 32. In one embodiment, inner lining 36 includes a sheet of thermally conductive material, such as metal, that may be formed to shape and disposed adjacent the inner surface of the housing 32 during assembly of the wireless telephone 30.

In another embodiment, inner lining 36 may be a layer of thermally conductive material that has been cured from a liquid form. Thermally conductive materials of this type may be applied by spraying or brushing the thermally conductive material onto the inner surface of the housing 32. After an elapsed period of time, the thermally conductive material may cure into a solid form and adhere to the housing 32.

In one embodiment, coupling of the housing 32 to the electrical component 12 may be provided by a thermo-electric cooler 40. The thermo-electric cooler 40 is a particular type of electrical device having two ends 42a and 42b that are configured to transfer heat between one another using the Peltier effect. In one embodiment, one end 42b of the thermo-electric cooler 40 is thermally coupled to light generating device 12b and the other end 40a is coupled to the heat spreading member, which in this particular embodiment, is the inner lining 36. When an appropriate electrical power source is applied, the thermo-electric cooler 40 may actively move heat from the light generating device 12b to the housing 32. The thermo-electric cooler 40 is generally referred to as an active thermal device in that heating or cooling of either of its ends 42 may be accomplished by application of an external power source, such as electrical power derived from a battery (not specifically shown) disposed in the wireless telephone housing 32. In one embodiment, the polarity of the thermo-electric cooler 40 may be reversed such that heat may be transferred from the wireless telephone housing 32 to the light generating device 12b. In this manner, the light generating device 12b may be operated in ambient temperatures well below its specified operating range. In some embodiments in which only active heating of light generating device 12b is desired, the active thermal device may be a resistor that is configured to provide heat to the light generating device 12b in order to raise its operating temperature.

Certain embodiments incorporating a thermo-electric cooler 40 for active cooling of electrical components 12, such as light generating devices 12b may provide an advantage in that the operating temperature may be controlled over a wider range than may be provided by passive cooling. For example, a wireless telephone 10 or 30 having a wireless telephone housing 14 or 32 with a thermal resistance of 20 degrees Celsius/Watt (° C./W) and an electrical component 12 that generates 1.0 Watt of heat will operate at 20 degrees Celsius above the ambient environment. If the maximum specified operating temperature of the electrical component 12 is 60 degrees Celsius, then operation of the wireless telephone in ambient environments above 40 degrees Celsius will cause the electrical component 12 to operate beyond its maximum specified operating temperature. However, use of the thermo-electric cooler 40 may allow use in ambient environments above 40 degrees Celsius by actively transferring heat to the housing 14 or 32.

In one embodiment, a controller circuit 34 may be used in conjunction with an active thermal device, such as thermo-electric cooler 40 or a resistor, to regulate the operating temperature of the light generating device 12b. The controller circuit 34 may include a thermal sensor 38 for thermally sensing the temperature of the light generating device 12b. In the event that the operating temperature exceeds an upper threshold temperature, the controller circuit 34 may adjust power to the active thermal device such that the operating temperature of the light generating device 12b is reduced. The controller circuit 34 may also be operable to adjust power to the active thermal device such that the operating temperature is increased if the operating temperature of the light generating device 12b exceeds a lower threshold temperature.

Certain embodiments incorporating an active thermal device, such as a thermo-electric cooler 40 or a resistor may provide an advantage in that the light generating device 12b may be rapidly brought to a desired operating temperature, for example, upon startup. Electrical components 12, such as light generating device 12b used with spatial light modulator 12a on wireless telephone 30 may experience relatively sporadic usage. These devices, however, may require a period of time to warm up to their desired operating temperature when turning from an “off” to an “on” state. Thus, it may be beneficial to actively heat the light generating device 12b to a desired operating temperature such that the latent warm up time of the light generating device 12b may be reduced. Thus, active thermal devices, such as thermo-electric coolers 40 or resistors may be used to reduce the latent warm time of the light generating device 12b in some embodiments.

FIG. 4 is a graph showing the luminous output power of an example laser as a function of its operating temperature. Luminous output power generally refers to a level of brightness or amount of light produced by the light generating device 12b. As can be seen, the light generating device 12b may have an operating temperature range 50 at which the luminous output power may have a relative maximum luminous output power 52. Although this particular graph may represent the luminous output power of one particular light generating device 12b, it should be appreciated that other light generating devices may also exhibit a relative maximum luminous output power 52 at various operating temperatures. Thus in one embodiment, the controller circuit 34 may be operable to control the active thermal device such that the operating temperature of the light generating device 12b is maintained proximate a relative maximum luminous output power 52 of the light generating device 12b. In another embodiment, the operating temperature range 50 of the light generating device 12b may be between the lower threshold temperature and the upper threshold temperature such the light generating device 12b may emit light at its relative maximum output power 52.

A wireless phone housing 14 or 32 for a wireless phone 10 or 30 has been described that may enable or enhance use of various electrical components 12 that generate heat during operation. Heat spreading members, such as heat pipes 18 or inner linings 36 provide dissipation of heat generated by the electrical component 12 in such a manner to reduce hot spots that may be harmful or annoying to users of the wireless telephone 10 or 30. Wireless phone housings 14 or 32 configured with active thermal devices may also be controlled by a controller circuit 34 to actively control the operating temperature of various electrical components 12, such as light generating devices 12b. For these light generating devices 12b, the operating temperature may be controlled such that light may be emitted at a relative maximum intensity. Certain embodiments in which the operating temperature of light generating devices 12b are controlled to emit light at a relative maximum intensity may provide an advantage in that a greater amount of light may provide for a corresponding greater image area and/or brightness of the image.

Although several embodiments have been illustrated and described in detail, it will be recognized that substitutions and alterations are possible without departing from the spirit and scope of the present invention, as defined by the following claims.

What is claimed is:

1. A wireless telephone comprising:
a housing for encasing a plurality of electrical components of a wireless telephone; and
a heat spreading member in thermal communication with at least two distally located portions of the housing, the heat spreading member being thermally conductive for reducing a thermal gradient over the surface of the housing.

2. The wireless telephone of claim 1, wherein the heat spreading member and the housing are integrally formed from one piece of material.

3. The wireless telephone of claim 2, wherein the material comprises magnesium.

4. The wireless telephone of claim 1, wherein the heat spreading member comprises a heat pipe.

5. The wireless telephone of claim 1, wherein the heat spreading member comprises a generally flat-shaped inner lining that is disposed adjacent to an inner surface of the housing.

6. The wireless telephone of claim 5, wherein the inner lining comprises a sheet of thermally conductive material.

7. The wireless telephone of claim 5, wherein the inner lining comprises a layer of thermally conductive material that has been cured from a liquid form.

8. The wireless telephone of claim 1, wherein the plurality of electrical components comprises a display, the display being free from contact with the heat spreading member.

9. The wireless telephone of claim 1, wherein the plurality of electrical components comprises a light generating device, the light generating device being operable to form a two-dimensional image using a device that is selected from the group consisting of a digital micro-mirror device, a scanning mirror, a liquid crystal on silicon (LCOS) device, and a transmissive liquid crystal display.

10. The wireless telephone of claim 9, wherein the light generating device is thermally coupled to the heat spreading member.

11. A wireless telephone comprising:
a housing for encasing one or more electrical components of a wireless telephone; and
a thermo-electric cooler thermally coupled between the housing and the one or more electrical components, the thermo-electric cooler operable to transfer heat from the one or more electrical components to the housing.

12. The wireless telephone of claim 11, wherein the one or more electrical components comprises a light generating device for generating a two-dimensional image using a device that is selected from the group consisting of a digital micro-mirror device, a scanning mirror, a liquid crystal on silicon (LCOS) device, and a transmissive liquid crystal display.

13. The wireless telephone of claim 12, wherein the light generating device is selected from the group consisting of light emitting diodes and lasers.

14. The wireless telephone of claim 11, wherein the thermo-electric cooler is further operable to transfer heat from the housing to the one or more electrical components.

15. A wireless telephone comprising:
a housing for encasing one or more electrical components;
an active thermal device coupled between the one or more electrical components and the housing; and
a controller circuit coupled to the active thermal device and operable to:
measure an operating temperature of the one or more electrical components; and
adjust electrical power to the active thermal device if the operating temperature becomes greater than an upper threshold temperature such that the operating temperature is reduced.

16. The wireless telephone of claim 15, wherein the active thermal device is a resistive element.

17. The wireless telephone of claim 15, wherein the active thermal device is a thermo-electric cooler.

18. The wireless telephone of claim 15, wherein the controller circuit is further operable to adjust electrical power to the active thermal device if the operating temperature becomes less than a lower threshold temperature such that the operating temperature is increased.

19. The wireless telephone of claim 18, wherein the one or more electrical components comprises a light generating device that is operable to emit light having a relative maximum luminous intensity at a particular temperature, the particular temperature being less than the upper threshold temperature and greater than the lower threshold temperature.

20. The wireless telephone of claim 15, wherein the one or more electrical components is a light generating device that is operable to form a two-dimensional image using a device that is selected from the group consisting of a digital micro-mirror device, a scanning mirror, a liquid crystal on silicon (LCOS) device, and a transmissive liquid crystal display.
